(19) United States
(12) Patent Application Publication
(10) Pub. No.: US 2013/0033359 A1
(43) Pub. Date: Feb. 7, 2013

(54) No-Click automate opener control system for gate, garage and the like

(71) Applicants: Wen Shu Ji, Alhambra, CA (US); Chau Dai Van, Alhambra, CA (US)

(72) Inventors: Wen Shu Ji, Alhambra, CA (US); Chau Dai Van, Alhambra, CA (US)

(21) Appl. No.: 13/136,580

(22) Filed: Aug. 3, 2011

(51) Int. Cl. G06F 7/00; E05F 15/20

(52) U.S. Cl. 340/5.7; 49/31

(57) ABSTRACT

A gate structure includes a gate control housing, a gate member and a control system. The control system includes a first and a second connector. The second connector is detachably attached on the moving object, and includes a signal generating module. The first connector and the second connector are communicated through a predetermined radio frequency signal. The gate member is operated between a closing position and an opening position, wherein in the closing position, a distance between the first and the second connector is larger than a preset connecting distance and the gate member is closed for blocking access to the restricted area, wherein in the opening position, a distance between the first connector and the second connector is within the preset connecting distance and the gate member is actuated to move for allowing access to the restricted area by the moving object bearing the first connector.

### BACKGROUND OF THE PRESENT INVENTION

1. Field of Invention

The present invention relates to an operation system for gate, garage and the like for a vehicle object, and more particularly to an opener control system for gates, garages and the likes which employ a no-click mechanism to automatically control the opening and closing of the gates and/or the garages.

2. Description of Related Arts

A conventional gate operator for opening and closing a gate of a building structure, such as a factory, an office building, a residential complex, and etc., generally comprises a transmitter and a receiver communicating with the transmitter. The receiver is connected to the gate. The transmitter is embodied in a remote control which includes a battery to power the transmitter, a signal generator and an on/off switch. The on/off switch is usually in the form of a button for controlling the signal transmission. The transmitter and the receiver are communicated with radio frequency.

In response to the status of the on/off switch, a signal will be generated and transmitted to the receiver to control the gate operation. The receiver actuates a mechanism to control the gate to open in response to an opening signal received from the transmitter and to close in response to a closing signal received from the transmitter.

In order to avoid fault actuations, a low transmission range radio frequency is generally used for transmission, so that the transmitter has to be close enough with the receiver for receiving a signal. In other words, a user inside a vehicle can only manually control and operate the gate between an opening position and a closing position in an immediate vicinity area of the gate. Therefore, the user has to stop the vehicle to operate and wait outside the gate for the gate operation that is inconvenient and inefficient. In fact, it is very dangerous to stop and wait inside the vehicle in the middle of a road. When a number of vehicles is lining up and waiting outside the gate, it is not only dangerous to the users of the waiting vehicles, but also dangerous to other moving vehicles on the road. In addition, the vehicles waiting outside the gate may block the road and cause traffic jam around the gate area.

Another popular arrangement of the gate operator which is mostly used in high density building structures or commercial building structures is the use of an infrared detector for actively detecting any vehicle appearing at the gate area. The use of infrared frequency which has a narrow range is disadvantageous as described above. In addition, in order to avoid the gate from being accidentally actuated to its closing position, the design and layout position of the detector are crucially vital. Therefore, costly and heavy construction work for installation of the detector must be involved.

Another conventional arrangement of the gate operator, mostly used in high density building structures or commercial building structures, is the use of a magnetic detector loop which requires construction scale installation and costly. The magnetic detector loop is extended underground of the gateway to detect the metal component of a passing vehicle such that the gate is actuated to open and remained in the opening position until the vehicle completely passing through the gate before actuating to close the gate again. Such gate operator is a security system but it is very costly and requires complicated construction at the gateway.

Since the control of the opening and closing of the gate relies on the sensor, it is important to install the sensor securely and accurately. However, the metallic parts of a vehicle and the presence of any magnetic force will greatly interfere with the operation of the sensor and thus additional construction work to install underground wiring is required. As a result, the installation cost for this type of gate and sensor is fairly high.

On the other hand, such sensor type gate operator is also dangerous in case of malfunction. The vehicle may be hit badly by the moving gate structure. Also, with the increasingly use of electrical parts and devices in a vehicle, the accuracy of the detecting ability of the sensor may be impaired. The worst thing is that the users will only know such conventional gate or garage is out of order when it failed to close again and that the gate will remain open until it is fixed.

### SUMMARY OF THE PRESENT INVENTION

The invention is advantageous in that it provides an operation system for gates, garages and the likes with a no-click mechanism which is safe and convenience but does not require complicated installation work.

Another advantage of the invention is to provide an automated operation system for gates, garages and the likes which is safe and convenience to use.

Another advantage of the present invention is to provide an operation system for gates, garages and the likes comprising a pair of connectors interactively communicated to control the opening and closing of the gate structure which does not require complicated installation work but is safe and convenience.

Another advantage of the present invention is to provide an operation system for gates, garages and the likes of a building structure, comprising a pair of connectors interactively communicated through radio frequency (RF) in a preset communicative distance to control the opening and closing of the gate/garage structure in such a manner that the gate/garage structure is controlled to an opening position right before the vehicle equipped with the connector of the system arrives at the gate/garage structure automatically such that the vehicle does not need to stop and the user of the vehicle does not need to operate any device and wait for the gate/garage structure to be opened.

Another object of the present invention is to provide an operation system for gates, garages and the likes of a building structure, comprising a pair of connectors interactively communicated to control the opening and closing of the gate/garage structure which is safe even when the system is malfunction or out of power, wherein the connectors control the gate/garage structure to an opening position when the pair of connectors are within a preset distance, and the opening position is maintained for a predetermined period of time and is changed to a closing position when the pair of connectors are not within the preset distance.

Additional advantages and features of the invention will become apparent from the description which follows, and may be realized by means of the instrumentalities and combinations particular point out in the appended claims.

According to the present invention, the foregoing and other objects and advantages are attained by providing a gate structure for selectively blocking a moving object from accessing a restricted area, comprising:

a gate control housing;

a gate member movably extended from the gate control housing for selectively opening and closing the gate structure; and

a control system, which comprises:

a first connector which is provided at the gate control housing, and comprises a first main body having a signal receiving module provided thereon provided at the ; and

a second connector which is detachably attached on the moving object, and comprises a second main body having a signal generating module provided thereon, wherein the first connector and the second connector are communicated through a predetermined radio frequency signal having a predetermined frequency, wherein the signal generating module of the second connector is arranged to automatically and periodically generate a connecting signal at the predetermined frequency, for operating the gate member between a closing position and an opening position, wherein in the closing position, a distance between the first and the second connector is larger than a preset connecting distance so that the gate member is closed for blocking access to the restricted area, wherein in the opening position, a distance between the first connector and the second connector is within the preset connecting distance so that the gate member is actuated to move for allowing access to the restricted by the moving object bearing the first connector, whereby, the gate structure is opened before the moving object arrives at the gate structure without requiring manual actuation of the second connector.

In accordance with another aspect of the invention, the present invention provides a method for operating a gate structure comprising a gate housing and a gate member movably extended from the gate housing, wherein the method comprises the steps of:

(a) providing a first connector in the gate housing, wherein the first connector comprises a signal receiving module;

(b) providing a second connector in a moving object, wherein the second connector is arranged to periodically and automatically send a connecting signal at the predetermined frequency to signal receiving module of the first connector;

(c) receiving the connecting signal by the first connector when the moving object moves within the connecting distance;

(d) actuating the gate member to open the gate structure for a preset period of time when the first connector receives the connecting signal so that the gate structure is opened before the moving object arrives at the gate structure without requiring manual actuation of the second connector; and

(e) actuating the gate structure to a closing position when the connecting signal is not received.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a control system for a gate structure according to a preferred embodiment of the present invention.

FIG. 2 is block diagram of the control system according to the above preferred embodiment of the present invention.

FIG. 3 is a schematic diagram showing an example of the control system for a gate, a garage or the like according to the above preferred embodiment of the present invention.

FIG. 4A and FIG. 4B are schematic diagrams of the first and the second connector of the control system respectively according to the above preferred embodiment of the present invention.

FIG. 5A and FIG. 5B are schematic diagrams of a first alternative mode of the control system according to the above preferred embodiment of the present invention.

### DETAILED DESCRIPTION OF THE PREFERRED EMBODIMENT

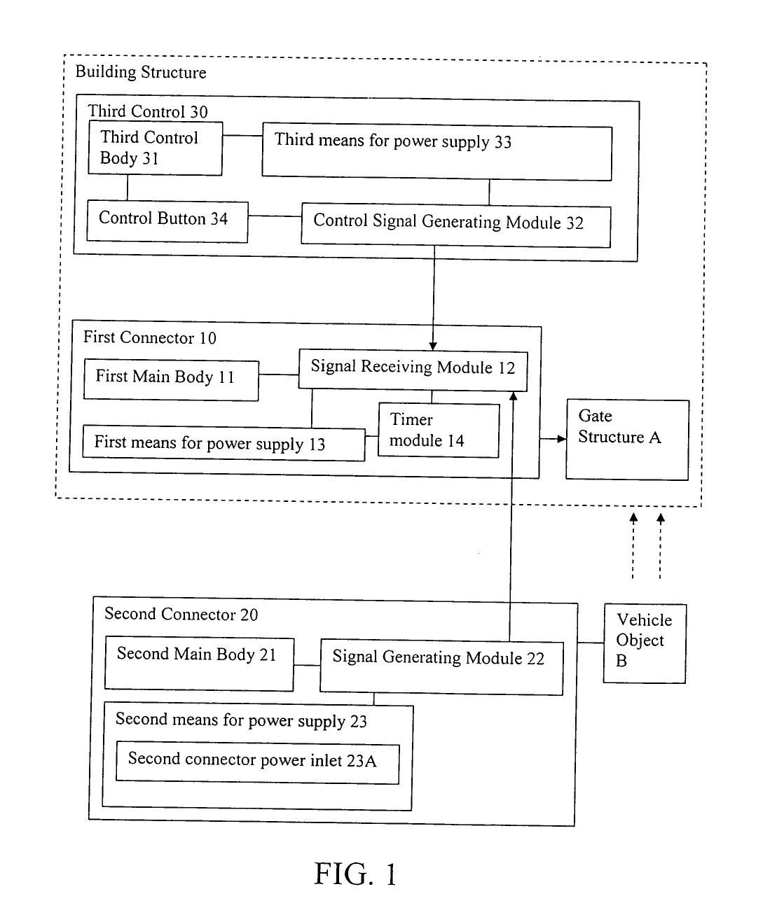

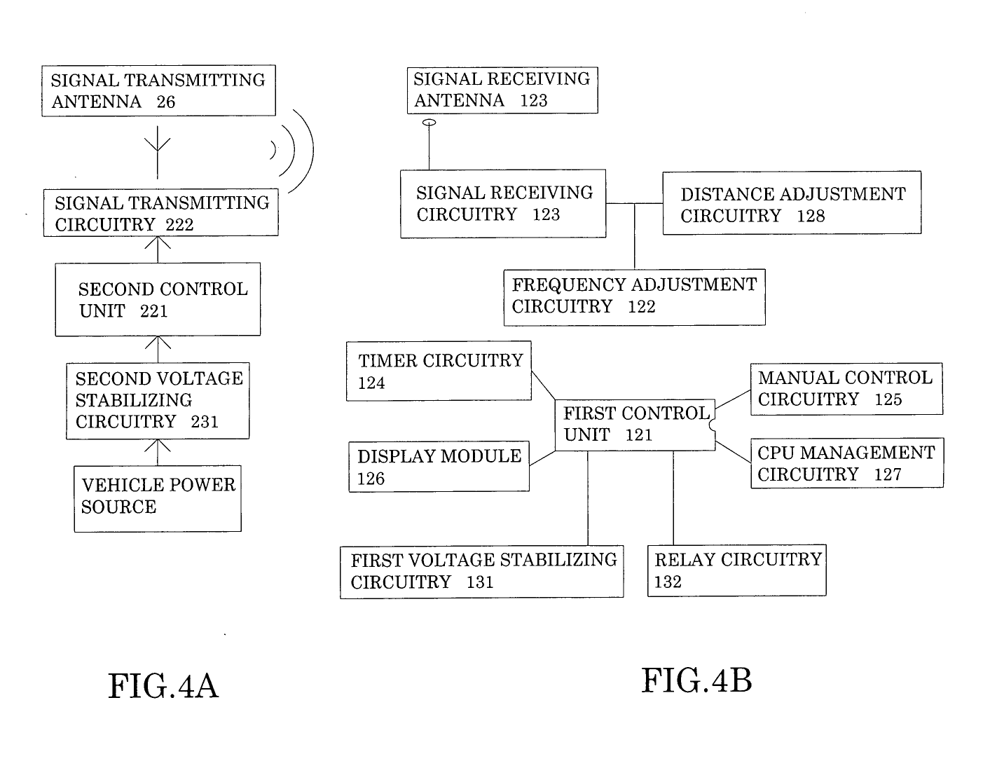

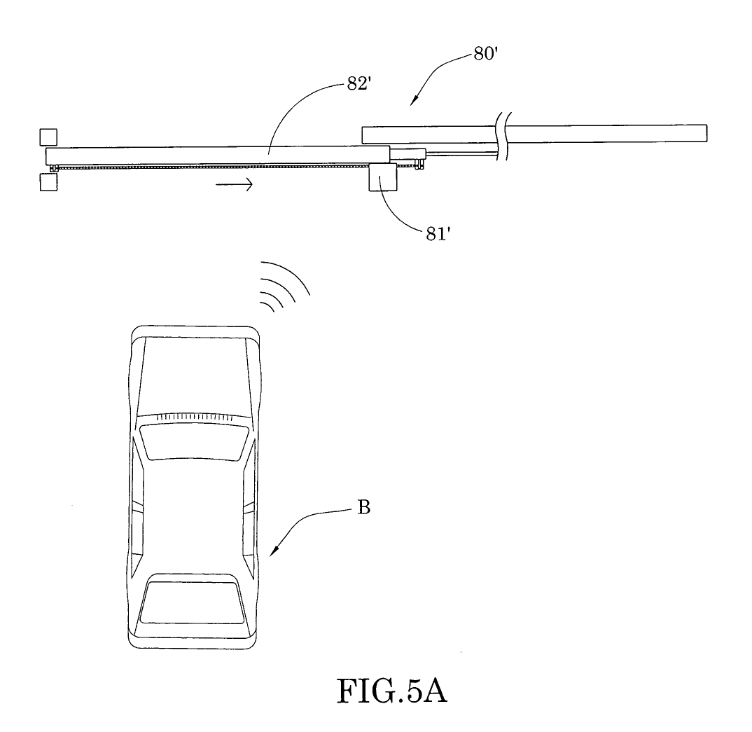

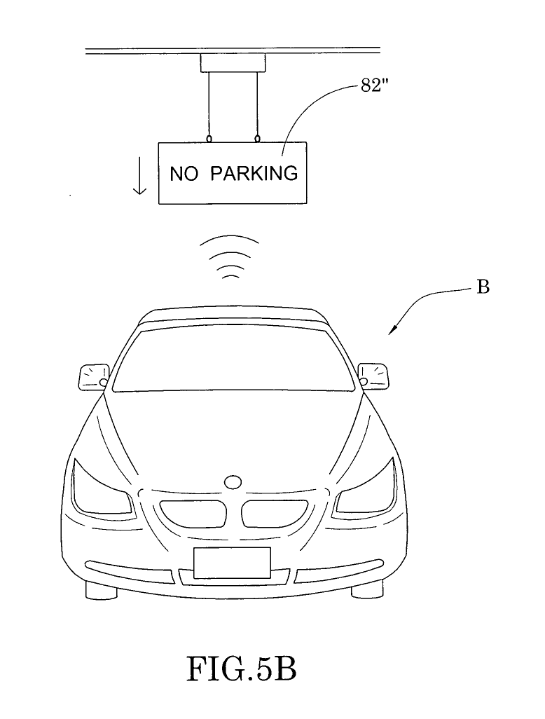

Referring to FIG. 1 to FIG. 3, FIG. 4A, FIG. 4B, FIG. 5A and FIG. 5B of the drawings, a gate structure for selectively blocking a moving object from accessing a restricted area according to a preferred embodiment of the present invention is illustrated. The gate structure 80 comprises a gate control housing 81 and a gate member 82. The control system is adapted for installing in a building structure where the entrance is gated and is for coupling in a vehicle object controlled by a user entering the building structure. The building structure can be a commercial building or residential complex with a shared main entrance, a single house or a condominium with an independent entrance, or even a park or recreational area which, technically speaking, does not have any building. Also, the gate structure includes any gate, garage, movable fences, or signs which used to control the access to and out of the building structure or the area guarded. The present invention is a gate and/garage opener control system for the vehicle object which does not require any manual clicking action by an operator.

According to the preferred embodiment, the present invention also provides an operation system for a gate structure, garage and the like of a building structure. The gate structure further comprises a control system comprising a first connector 10 and a second connector 20, wherein the second connector 20 is electrically and wirelessly connected with the first connector 10 through radio frequency signal at a predetermined frequency range.

More specifically, the first connector 10 is provided at the gate control housing 81, and comprises a first main body 11 and a signal receiving module 12 provided thereon provided at the gate control housing 81.

On the other hand, a second connector 20 is detachably attached on the moving object, and comprises a second main body 21 having a signal generating module 22 provided thereon, wherein the first connector 10 and the second connector 20 are communicated through a predetermined radio frequency signal having a predetermined frequency, wherein the signal generating module 22 of the second connector 20 is arranged to automatically and periodically generate a connecting signal at the predetermined frequency for connecting with the first connector 10, so as to operate the gate member 82 between a closing position and an opening position. In the closing position, a distance between the first and the second connector is larger than a preset connecting distance so that the gate member 82 is closed for blocking access to the restricted area. In the opening position, a distance between the first connector and the second connector is within the preset connecting distance so that the gate member 82 is actuated to move for allowing access to the restricted by the moving object bearing the first connector 10. Thus, the gate structure 80 is opened before the moving object arrives at the gate structure 80 without requiring manual actuation of the second connector 20.

The first connector 10 further comprises a first means for supplying power (referred hereinafter as first power supply means 13) to the first connector 10, wherein the power supply means 13 is mounted on the first connector 10 and includes a battery, a power inlet for obtaining power from an external power source such as a power source from the vehicle, or a combination of the battery and the power inlet.

The signal receiving module 12 of the first connector 10 is mounted on the first main body 11 and is electrically connected to the first power supply means 13, wherein the signal receiving module 12 is arranged to receive the radio frequency connecting signal at the preset frequency.

The signal generating module 22 of the second connector 20 is mounted on the second main body 21 and is arranged to generate the connecting signal at the preset frequency so as to communicate with the first connector 10. The connecting signal has a maximum connecting distance and a desired connecting distance D. The maximum distance is the maximum distance of which the first connector 10 and the second connector 20 are capable of connecting and communicating while the desired connecting distance D is equal to or smaller than the maximum distance and is determined by the user of the present invention.

The first connector 10 also provides a timer module 14 adapted for presetting a period of delay time. The first connector 10, in response to the connecting signal of the second connector 20, will actuate the gate structure to the opening position for the period of delay time. If no connecting signal is received from the first connector 10, the first connector 10 will actuate the gate structure 80 to the closing position. That is to say, the gate structure is maintained at the opening position through the connecting signals received at each preset sending time interval from the first connector 10 and the gate structure will no longer be maintained at the opening position if no connecting signal is received from the first connector 10.

The second main body 21 is generally carried in a moving object such as a vehicle (e.g. object B) or a human being comprises a second means for supplying power (hereinafter referred to as second power supply means 23) to the second connector 20. The second power supply means 23 comprises a power inlet for obtaining power from an external power source or a rechargeable battery. The power inlet is adapted for connecting to the battery or power source of the vehicle object B for power supply to the second connector 20. According to the preferred embodiment of the present invention, the second power supply means is preferably a second connector power inlet 23A adapted for obtaining power from the vehicle object B. The power inlet 23A is compatible to a cigarette lighter receptacle and to the USB standard. The second connector 20, which is adapted to sending the connecting signal continuously at a preset sending time interval obtains stable power supply through the vehicle object B. The power consumption of the second connector 20 is low, which is approximately 0.05 mA.

The first connector 10 is mounted in the building structure and the second connector 20 is positioned in the vehicle object B. When the vehicle object B coupling with the second connector 20 is moving towards the gate structure A with the first connector 10 installed and has reached the desired distance, the gate structure A is actuated to the opening position such that by the time the vehicle object B arrives at the gate structure A, the gate is fully opened with the gate member 82 driven to move to the opening position. That is to say, the user of the vehicle object B does not need to do anything and wait for the gate to be opened outside the gate structure A and therefore does not block any traffic.

On the other hand, when the vehicle object B is moving away from the building structure A and at a distance greater than the desired distance such that the connecting signal is not received from the connector A, the gate structure A is then not actuated to maintain the opening position and is actuated to drive the gate member 82 to move to the closing position. When the gate structure is driven to move to the opening position in response to the connecting signal at the preset sending time interval, the gate structure A is maintained at the opening position for a period of delay time for each connecting signal before the connecting signal is not received from the connector A and the gate structure A (i.e. the gate member 82) is actuated to move to the closing position.

Therefore, if the second connector 20 is out of order or the connecting signal is not generated during entry of the vehicle object B, the gate structure 80 will not be closed immediately and a period of delay time is provided to safeguard the entry of the vehicle object. As a result, in eliminating the waiting time outside the gate structure 80 and the above safeguard, the present invention has a higher safety standard when compared to the operation of the conventional gate opener.

It is worth mentioning that the preset frequency which is embodied as a radio frequency is adjustable through the first connector 10 and the second connector 20 respectively. The connecting signal generated by the second connector 20 may further include an identification code which is preprogrammed in the first connector 10 and the second connector 20 respectively. The first connector 10, in receiving the connecting signal including the identification code from the second connector 20, will then actuate the gate structure A to its opening position.

When the control system for a gate structure of the present invention is used in a residential complex which includes a plurality of users, a plurality of the second connectors 20 can be provided to electrically connect to a single first connector 10 placed at the complex entrance such that the first connector 10, in response to each of the second connectors 20, will selectively actuate the gate structure to the opening position and to the closing position.

According to the preferred embodiment, the present invention may further provide at least a third control 30 for manually controlling the gate structure to the opening position and the closing position respectively. The third control 30 comprises a third control body 31, a control signal generating module 32 mounted on the control main body 31, a third means for supplying power (hereinafter referred to as third power supply means 33) mounted on the third control body 31 and is electrically connected to the control signal generating module 32 for providing power to the third control 30, and a control switch 34 provided on the control body 31 electrically connected to the control signal generating module 32 for generating a connecting signal. The control signal generating module 32, in response to an opening command inputted through the control switch 34, will generate a connecting signal at a preset frequency to communicate with the first connector 10 such that the gate structure is controlled to the opening position.

On the other hand, in the absence of any connecting signal generated from the third control 30, no connecting signal is received from the first connector 10 and therefore the gate structure is controlled to the closing position. Therefore, a user of the third control 30 can open and close the gate structure respectively such that visitors to the building structure can get access to the building structure by manual operation of the user. This is particular useful for property management of private commercial property or housing community where guest or visitor is allowed to enter into the building structure.

Referring to FIG. 4A of the drawings, the signal generating module 22 of the second connector 20 comprises a second control unit 221 and a signal transmitting circuitry 222 electrically connected with the second control unit 221 for generating and transmitting radio frequency signal to the second connector 20. The second connector 20 further comprises a signal transmitting antenna 26 provided on the second main body 21 and is electrically connected to the signal generating module 22 for wirelessly transmitting radio frequency signal to the first connector 10.

The signal generating module 22 is electrically connected to the second power supply means 23 so as to be powered by a suitable power source. Moreover, the second power supply means 23 further comprises a second voltage stabilizing circuitry 231 for controlling and stabilizing the power supplied to the signal generating module 22.

Referring to FIG. 4B of the drawings, the signal receiving module 12 of the first connector 10 comprises a first control unit 121, a frequency adjustment circuitry 122 electrically connected to the firs control unit 121 for adjusting the frequency of the wireless signal which is arranged to activate the gate member 82 to move to the opening position, a signal receiving antenna 123 mounted on the first main body 11, a signal to receiving circuitry 123 electrically connected with the signal receiving antenna 123 and the frequency adjustment circuitry 122 for receiving wireless signal generated from the second connector 20, and a distance adjustment circuitry 128 electrically connected to the signal receiving circuitry and the frequency adjustment circuitry 122 for allowing adjustment of the connecting distance for activating the gate member 82 to move between the closing position and the opening position.

The signal receiving module 12 further comprises timer circuitry 124 and a manual control circuitry 125 electrically connected to the first control unit 121 for counting time and allowing selective manual control of the gate member 82 respectively. The timer circuitry 124 is arranged to send timing signal to the first control unit 121 for activating the gate member 82 to move between the opening position and the closing position.

Furthermore, the signal receiving module 12 further comprises a display module 126 and a CPU management circuitry 127 electrically connected to the first control unit 121 for displaying predetermined information to users of the present invention and for managing the first control unit 121 respectively.

On the other hand, the first power supply means 13 further comprises a first voltage stabilizing circuitry 131 and a relay circuitry 132 electrically connected to the signal receiving module 12 for providing stabilized power supply to the signal receiving module 12.

A distinctive feature of the present invention is that users may purchase the second connector 20 any time and use it for gaining access to the restricted area. For first time user, the identification code delivered by the second connector 20 may activate it so that the first connector 10 allows the second connector 20 to gain access to the restricted area (i.e. by driving the gate member 82 to move to the opening position) in the future. Thus, the signal receiving module 12 of the first connector 10 is pre-programmed to store a plurality of unused identification codes so that when an unused second connector 20 sends the unused identification code to the first connector 10, the unused identification code is activated to allow become a workable identification code in the future for the purpose of actuating the gate member 82 to move to the opening position.

It is worth mentioning that the connecting distance of the present invention can be adjusted to fit different operation circumstances. A predetermined number of identification codes (such as two hundreds identification codes) can be pre-programmed into the first connector 10 so that the corresponding number of second connectors 20 can be used for selectively activating the gate member 82. These identification codes can be deleted from being stored in the first connector 10 so that when some of the existing users cease to use the gate structure, their identification codes are deleted from the first connector 10 so that they can no longer gain access to the restricted area.

Moreover, it is worth mentioning that the wireless signals are intermittedly transmitted between the first and the second connector 10, 20 so as to effectively prevent interference from other equipments. Each of the first and the second connectors 10, 20 further comprises a control panel 40 provided thereon for allowing users to input commands.

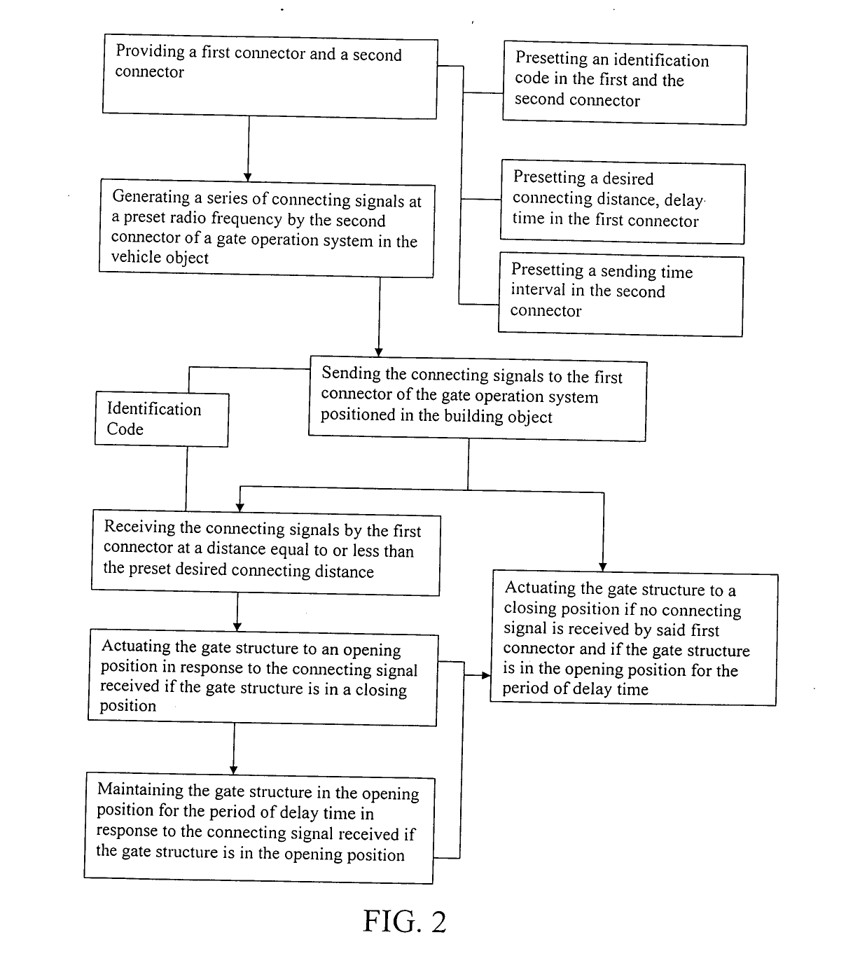

Referring to FIG. 2 of the drawings, an operation method for opening and closing gate or garage in a building structure according to the preferred embodiment of the present invention is illustrated. The operation method for a gate structure of a building structure communicating with a vehicle object, comprising the steps of:

(a) providing a first connector 10 in the gate housing 81, wherein the first connector 10 comprises a signal receiving module 12;

(b) providing a second connector 20 in a moving object, wherein the second connector 20 is arranged to periodically and automatically send a connecting signal at the predetermined frequency to signal receiving module 12 of the first connector 10;

(c) receiving the connecting signal by the first connector 10 when the moving object moves within the connecting distance;

(d) actuating the gate member 82 to open the gate structure for a preset period of time when the first connector 10 receives the connecting signal so that the gate structure is opened before the moving object arrives at the gate structure without requiring manual actuation of the second connector 20; and

(e) actuating the gate structure to a closing position when the connecting signal is not received (i.e. for the period of delay time).

Therefore, when the vehicle object B approaching the gate structure A has reached the desired connecting distance D, the gate structure A is actuated to the opening position such that at the time the vehicle object B arrives at the gate structure, the gate is fully opened at the opening position. The vehicle object B can then enter into the building structure without the need to do anything and wait for the gate structure to be opened. The preset frequency is a preset value with a radio frequency range.

In step (d), the period of delay time provides an extra safeguard. If the second connector is out of order or the connecting signal is failed to be generated during entry of the vehicle object, the gate structure will not be closed immediately and the period of delay time is important to safeguard the entry of the vehicle object.

In order to provide additional security, the method also provides an identification code with the following steps:

(a.1) providing a first connector 10 in the building structure or the gate structure having a signal receiving module 12 and a second connector 20 in the vehicle object having a signal generating module 22, the first connector 10 and the second connector 20 has a preset identification code respectively;

(b.1) sending a connecting signal together with the identification code at a preset frequency to the first connector 10 through the second connector 20; and

(c.1) receiving the connecting signal with the identification code by the first to connector 10 at a desired connecting distance which is equal to or less than a preset distance value of the desired connecting distance.

Therefore, when the vehicle object B approaching the gate structure A has reached the desired connecting distance D, the gate structure A is actuated to an opening position such that at the time the vehicle object B arrives at the gate structure, the gate member 82 is fully opened at the opening position. The vehicle object B can then enter into the building structure without the need to wait for the gate structure to be opened.

In particular, the operation method for the gate structure comprises the steps of:

(a) generating a series of connecting signals at a preset sending time interval at a preset radio frequency from the second connector 20 of a gate operation system positioned in and powered through the vehicle object;

(b) sending the series of connecting signals to a first connector 10 of the gate operation system positioned in the building object, wherein the first connector 10 is set at a standby mode and has a preset period of delay time;

(c) receiving the connecting signals by the first connector 10 if the distance between the first connector 10 and the second connector 20 is equal to or less than a preset desired connecting distance; and

(d) actuating the gate structure to an opening position in response to the connecting signal received by the first connector 10 if the gate structure is in a closing position;

(e) maintaining the gate structure in the opening position for the period of delay time in response to the connecting signal received by the first connector 10 if the gate structure is in the opening position; and

(f) actuating the gate structure to a closing position in response to the first connector if no connecting signal is received by the first connector 10 and if the gate structure is in the opening position for the period of delay time, wherein the period of delay time is longer than the preset sending time interval and whereby the gate structure is actuated to the opening position before the vehicle object arrives at the gate structure and is open when the vehicle object arrives at the gate structure for the vehicle object to passing the gate structure without delay.

It is worth mentioning that the preferred period of delay time is approximately 5 seconds to 1 minute and the preferred preset sending time interval is approximately 1 to 4 seconds. In the preferred embodiment of the present invention, the delay time is 5 seconds and the preset sending time interval 3 seconds.

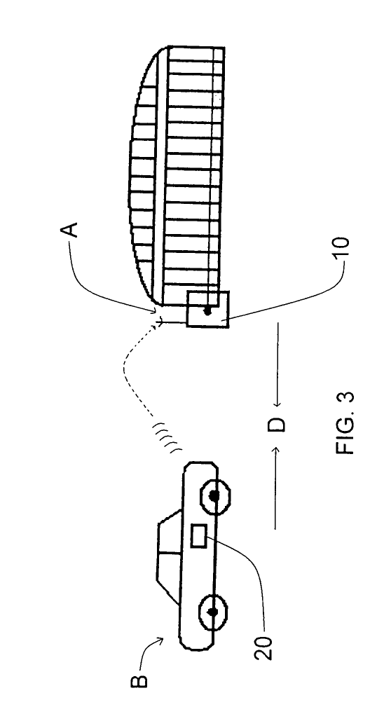

Referring to FIG. 3 of the drawings, an application example of the opener control system for a gate and garage structure according to the preferred embodiment of the present invention is illustrated, wherein the vehicle object B is approaching the building structure having a gate structure A, that the first connector 10 which is a receiver is positioned in the building structure and the second connector 20 which is a transmitter is positioned in the vehicle object.

The first connector 10, as shown in FIG. 3 of the drawings, comprises a main body 11, the first main body 11 comprising the first power supply means 13 which provides power to the first connector 10, a signal receiving module 12 mounted on the first main body 11 which is electrically connected to the first means for power supply 13 wherein the signal receiving module 12 is adapted to receiving a connecting signal at a preset frequency.

The second connector 20, as shown in FIG. 3 of the drawings, comprises the second main body 21 and the signal generating module 22 mounted on the second main body 21 adapted for generating a connecting signal at a preset frequency at the preset sending time interval so as to communicate with the first connector 10. The desired connecting distance D as shown in FIG. 3 is preset within the range between 30 to 60 feet. The first connector 10 is capable of receiving the connecting signal at the preset frequency at a distance equal to or smaller than the desired connecting distance D. The second power supply means 23 used in this example is a power inlet mounted on the second connector 20 which is a cigarette lighter plug connecting to a cigarette lighter receptacle of the vehicle object B for power supply. Alternately, the second power supply means 23 is a power inlet electrically installed and connected to the vehicle object for power supply.

The first connector 10 is arranged to be on a standby mode on a 24 hours basis. The signal generating module 22 of the second connector 20 is adapted for generating the connecting signal at a preset frequency at the preset sending time interval continuously once connecting to the vehicle and obtaining power supply from the vehicle object B. The first connector 10 and the second connector 20 have a preset identification code respectively.

When the vehicle object B coupling with the second connector 20 is moving towards the gate structure A of the building structure with the first connector 10 installed and has reached the desired distance D, which is about 30 to 60 feet in this example, the signal receiving module 12 of the first connector 10 is capable of receiving the connecting signal including the identification code. Therefore, the gate structure A is actuated to an opening position such that at the time the vehicle object B arrives at the gate structure, the gate is fully opened at the opening position.

That is to say, the user of the vehicle object does not need to do anything and to wait for the gate to be opened outside the gate structure. Also, since the second connector 20 is sending the connecting signal at each preset sending time interval continuously, the gate structure will remain in the opening position when the vehicle object B is passing through the gate structure. Compared to other type of gate opener system, the sending of connecting signal consecutively provide a safeguard to prevent the closure of the gate structure to hit the vehicle object while the vehicle object is passing the gate structure, without the need of heavy construction work or costly installation involving magnetic detector loop or infrared detector or the like for providing safety measure.

On the other hand, when the vehicle object B is moving away from the building structure and at a distance greater than the desired distance D such that the connecting signal is not received from the connector A, or when the vehicle B is parked and powered off that no power is supplied to the second connector 20, the gate structure A is then not actuated to maintain the opening position and is actuated to a closing position. In particular, when the gate structure A is controlled to the opening position in response to the connecting signal at the preset sending time interval, the gate structure A is maintained at the opening position for a period of delay time for each connecting signal. After the period of delay time, if the connecting signal is not received from the connector

A, the gate structure A is no longer maintained in the opening position and is actuated to the closing position.

It is worth mentioning that the period of delay time is longer than the preset sending time interval. The preferred period of delay time is approximately 5 to 10 seconds and the preferred preset sending time interval is approximately 1 to 4 seconds. In the example as shown in FIG. 3, the delay time is 5 seconds and the preset sending time interval 3 seconds.

The application of the control system for a gate structure according to the preferred embodiment of the present invention in a building structure is further illustrated. One first connector 10 which is a receiver can be used with a plurality of second connectors 20 such that multiple authorized users are allowed to have controlled access to the building structure. Conversely, one second connector 20 which is a transmitter can be used with a plurality of first connectors 10 such that the user can have controlled access to two building structures, such as home and office, with one second connector 20.

Referring to FIG. 5A to FIG. 5B of the drawings, a first alternative mode of the control system according to the preferred embodiment of the present invention is illustrated, wherein the first alternative mode is similar to the preferred embodiment except the control system is used to control a gate structure. In the alternative mode, the gate member 82′ of the gate structure 80′ may be embodied as many different types of fences or signs in order to prevent access to the restricted area by those who are not authorized holders of the second connectors 20. As shown in FIG. 5A of the drawings, the control system is used to gain access to a parking space, wherein the gate member 82′ is embodied as a fence, which is operated between the closing position and the opening position as well (similar to the gate member 82′ discussed in the preferred embodiment above). The gate control housing 81′ is located near the gate member 82′.

As shown in FIG. 5B of the drawings, the gate member 82″ is embodied as a sign which contain a predetermined wording such as “NO PARKING”. The gate member 82″ is suspendedly supported by the gate control housing 81 and the control system of the present invention is utilized for preventing unauthorized parking.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A gate structure for selectively blocking a moving object from accessing a restricted area, comprising
a gate control housing;
a gate member movably extended from said gate control housing for selectively opening and closing said gate structure; and
a control system, which comprises:
a first connector which is provided at said gate control housing, and comprises a signal receiving module; and
at least one second connector which is detachably attached on said moving object, and comprises a signal generating module provided, thereon, wherein said first connector and said second connector are communicated through a predetermined radio frequency signal having a predetermined frequency, wherein said signal generating module of said second connector is arranged to automatically and periodically generate a connecting signal at said predetermined frequency, wherein said gate member is operated between a closing position and an opening position, wherein in said closing position, a distance between said first and said second connector is larger than a preset connecting distance and said gate member is closed for blocking access to said restricted area, wherein in said opening position, a distance between said first connector and said second connector is within said preset connecting distance and said gate member is actuated to move for allowing access to said restricted by said moving object bearing said first connector, so that said gate structure is opened before said moving object arrives at said gate structure without requiring manual actuation of said second connector.

2. The gate structure, as recited in claim 1, wherein said first connector comprises a timer module for allowing setting of a period of delay time, wherein said first connector, in responsive to said connecting signal of said second connector is arranged to actuate said gate member to said opening position for said period of delay time, wherein when no connecting signal is received from said first connector, said first connector is arranged to drive said gate member to said closing position.

3. The gate structure, as recited in claim 2, wherein said connecting signal generated by said second connector contains an identification code which is pre-programmed in said first connector and said second connector, wherein said identification code transmitted by said second connector matches with said identification code pre-programmed in said first connector, said first connector is arranged to actuate said gate member to said opening position.

4. The gate structure, as recited in claim 3, wherein said signal receiving module of said first connector comprises a first control unit, a frequency adjustment circuitry electrically connected to said firs control unit for adjusting said frequency of said wireless signal which is arranged to activate said gate member to move to said opening position, a signal receiving antenna mounted on said first connector, a signal receiving circuitry electrically connected with said signal receiving antenna and said frequency adjustment circuitry for receiving wireless signal generated from said second connector, and a distance adjustment circuitry electrically connected to said signal receiving circuitry and said frequency adjustment circuitry for allowing adjustment of said connecting distance for selectively activating said gate member to move between said closing position and said opening position.

5. The gate structure, as recited in claim 4, wherein said signal generating module of said second connector comprises a second control unit and a signal transmitting circuitry electrically connected with said second control unit for generating and transmitting radio frequency signal to said first connector, wherein signal generating module is electrically connected to said second power supply means.

6. The gate structure, as recited in claim 5, wherein signal receiving module further comprises a display module and a CPU management circuitry electrically connected to said first control unit for displaying predetermined information to users of and for managing said first control unit respectively.

7. The gate structure, as recited in claim 6, further comprising a third control wirelessly communicated with said first connector for manually controlling said gate member to move between said opening position and said closing position.

8. The gate structure, as recited in claim 7, further comprising a plurality of said second connectors electrically and wirelessly communicated with said first connector, wherein said first connector is arranged to actuate said gate member between said opening position and said closing position when said first connector receives a valid wireless signal from at least one of said second connectors.

9. A control system for a gate structure comprising a gate control housing and a gate member movably extended from said gate control housing for selectively opening and closing said gate structure, wherein said control system comprises:
a first connector which is provided at said gate control housing, and comprises a signal receiving module; and
at least one second connector which is detachably attached on said moving object, and comprises a signal generating module provided thereon, wherein said first connector and said second connector are communicated through a predetermined radio frequency signal having a predetermined frequency, wherein said signal generating module of said second connector is arranged to automatically and periodically generate a connecting signal at said predetermined frequency, wherein said gate member is operated between a closing position and an opening position, wherein in said closing position, a distance between said first and said second connector is larger than a preset connecting distance and said gate member is closed for blocking access to said restricted area, wherein in said opening position, a distance between said first connector and said second connector is within said preset connecting distance and said gate member is actuated to move for allowing access to said restricted by said moving object bearing said first connector, so that said gate structure is opened before said moving object arrives at said gate structure without requiring manual actuation of said second connector.

10. The control system, as recited in claim 9, wherein said first connector comprises a timer module for allowing setting of a period of delay time, wherein said first connector, in responsive to said connecting signal of said second connector is arranged to actuate said gate member to said opening position for said period of delay time, wherein when no connecting signal is received from said first connector, said first connector is arranged to drive said gate member to said closing position.

11. The control system, as recited in claim 10, wherein said connecting signal to generated by said second connector contains an identification code which is pre-programmed in said first connector and said second connector, wherein said identification code transmitted by said second connector matches with said identification code pre-programmed in said first connector, said first connector is arranged to actuate said gate member to said opening position.

12. The control system, as recited in claim 11, wherein said signal receiving module of said first connector comprises a first control unit, a frequency adjustment circuitry electrically connected to said firs control unit for adjusting said frequency of said wireless signal which is arranged to activate said gate member to move to said opening position, a signal receiving antenna mounted on said first connector, a signal receiving circuitry electrically connected with said signal receiving antenna and said frequency adjustment circuitry for receiving wireless signal generated from said second connector, and a distance adjustment circuitry electrically connected to said signal receiving circuitry and said frequency adjustment circuitry for allowing adjustment of said connecting distance for selectively activating said gate member to move between said closing position and said opening position.

13. The control system, as recited in claim 12, wherein said signal generating module of said second connector comprises a second control unit and a signal transmitting circuitry electrically connected with said second control unit for generating and transmitting radio frequency signal to said first connector, wherein signal generating module is electrically connected to said second power supply means.

14. The control system, as recited in claim 13, wherein signal receiving module further comprises a display module and a CPU management circuitry electrically connected to said first control unit for displaying predetermined information to users of and for managing said first control unit respectively.

15. The control system, as recited in claim 14, further comprising a third control wirelessly communicated with said first connector for manually controlling said gate member to move between said opening position and said closing position.

16. The control system, as recited in claim 15, further comprising a plurality of said second connectors electrically and wirelessly communicated with said first connector, wherein said first connector is arranged to actuate said gate member between said opening position and said closing position when said first connector receives a valid wireless signal from at least one of said second connectors.

17. A method of operating a gate structure comprising a gate control housing and a gate member movably extended from said gate control housing for selectively opening and closing said gate structure, wherein said method comprises the steps of:
(a) providing a first connector in said gate control housing, wherein said first connector comprises a signal receiving module;
(b) providing at least one second connector in a moving object, wherein said second connector is arranged to periodically and automatically send a connecting signal at said predetermined frequency to signal receiving module of said first connector;
(c) receiving said connecting signal sent by said first connector when said moving object moves within a predetermined connecting distance;
(d) actuating said gate member to open said gate structure for a preset period of time when said first connector receives said connecting signal so that said gate structure is opened before said moving object arrives at said gate structure without requiring manual actuation of said second connector; and
(e) actuating said gate structure to a closing position when said connecting signal is not received.

18. The method, as recited in claim 17, wherein in said step (b), said connecting signal generated, by the second connector includes an identification code which is preprogrammed in said first connector and said second connector respectively, wherein said first connector, in receiving said connecting signal including said identification code from the second connector, is arranged to actuate said gate member to said opening position.

19. The method, as recited in claim 18, wherein said step (c) comprises a step of receiving said connecting signal with said identification code by said first connector at said connecting distance which is equal to or less than a preset distance value of said connecting distance.

20. The method, as recited in claim 18, further comprising a step of maintaining said gate member in said opening position for said period of a delay time in response to said connecting signal received by said first connector when said gate member is in said opening position.

21. The method, as recited in claim 19, further comprising a step of maintaining said gate member in said opening position for said period of a delay time in response to said connecting signal received by said first connector when said gate member is in said opening position.

22. The method, as recited in claim 20, wherein said step (e) comprises a step of actuating said gate structure to a closing position when no connecting signal is received by said first connector and when said gate structure is in said opening position for said period of delay time.

23. The method, as recited in claim 21, wherein said step (e) comprises a step of actuating said gate structure to a closing position when no connecting signal is received by said first connector and when said gate structure is in said opening position for said period of delay time

24. The method, as recited in claim 17, wherein said step (b) further comprises a step of providing a plurality of second connectors on a corresponding number of said moving objects wherein said second connectors are electrically and wirelessly communicated with said first connector.

25. The method, as recited in claim 23, wherein said step (b) further comprises a step of providing a plurality of second connectors on a corresponding number of said moving objects wherein said second connectors are electrically and wirelessly communicated with said first connector.

26. The method, as recited in claim 24, wherein said step (d) comprises a step of actuating said gate member to said opening position when said first connector receives a valid wireless signal from at least one of said second connectors.

27. The method, as recited in claim 25, wherein said step (d) comprises a step of actuating said gate member to said opening position when said first connector receives a valid wireless signal from at least one of said second connectors.
